(19) United States
(12) Patent Application Publication
(10) Pub. No.: US 2025/0016295 A1
(43) Pub. Date: Jan. 9, 2025

(54) CAMERA MODULE WITH CHROMATIC ABERRATION CORRECTION

(71) Applicant: Meta Platforms Technologies, LLC, Menlo Park, CA (US)

(72) Inventors: Likai Li, Cupertino, CA (US); Eddie Alex Azuma, Pleasanton, CA (US)

(21) Appl. No.: 17/501,224

(22) Filed: Oct. 14, 2021

(51) Int. Cl. H04N 9/64; G02B 27/10; G02B 27/14; G06T 5/00; G06T 5/50; G06T 7/80; H04N 9/097

(52) U.S. Cl. CPC H04N 9/646; G02B 27/1013; G02B 27/141; G06T 5/50; G06T 5/80; G06T 7/80; H04N 23/16; G06T 2207/10024; G06T 2207/20212

(57) ABSTRACT

An apparatus, system, and method for an imaging system that compensates for chromatic aberration. The imaging system may include a metalens that provides image light to a camera module. The camera module may include an optical splitter and a number of image sensors. The optical splitter separates the image light into a number of color components. The optical splitter directs the number of color components to individual image sensors. Processing logic may adjust image data for each of the color components to compensate for chromatic aberration. Processing logic may form a single chromatic aberration corrected image by recombining the adjusted image data from each of the color components.

### TECHNICAL FIELD

This disclosure relates generally to optics, and in particular to chromatic aberration correction.

### BACKGROUND INFORMATION

Chromatic aberration, also known as color fringing, is a color distortion that can create an outline of unwanted color along the edges of objects in an image. It may appear along metallic surfaces or where a high contrast exists between light and dark objects, such as a black surface in front of a brightly colored surface. Chromatic aberration and other image distortion issues have limited the universal implementation of some of the more advanced optical technologies.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head mounted display, in accordance with aspects of the disclosure.

FIG. 2 illustrates an imaging system that includes chromatic aberration correction, in accordance with aspects of the disclosure.

FIGS. 3A and 3B illustrate example implementations of an optical element, in accordance with aspects of the disclosure.

FIGS. 4A and 4B illustrate example implementations of an optical element, in accordance with aspects of the disclosure.

FIG. 5 illustrates an imaging system that includes chromatic aberration correction, in accordance with aspects of the disclosure.

FIG. 6 illustrates a flow diagram of a process for correcting chromatic aberration, in accordance with aspects of the disclosure.

### DETAILED DESCRIPTION

Embodiments of an imaging system that compensates for chromatic aberration is described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In aspects of this disclosure, visible light may be defined as having a wavelength range of approximately 380 nm to 700 nm. Non-visible light may be defined as light having wavelengths that are outside the visible light range, such as ultraviolet light and infrared light. In aspects of this disclosure, red light may be defined as having a wavelength range of approximately 620 to 750 nm, green light may be defined as having a wavelength range of approximately 495 to 570 nm, and blue light may be defined as having a wavelength range of approximately 450 to 495 nm.

In aspects of this disclosure, a metalens may be defined as an optical element having at least one metasurface. A metasurface is a surface that may have arrays of nanostructures designed to manipulate incoming light. Metalenses may be optically thin (e.g., 80-120 nm thick) and may be designed to control the amplitude, phase, and/or polarization of transmitted light.

Although metalenses are thinner than conventional lenses, distortion characteristics of metalenses have impacted or halted incorporation of metalenses into various technologies. In particular, light transmitted through a metalens may be subject to chromatic aberration, which may cause aspects of images to be blurry and unclear.

Embodiments of the present disclosure include an imaging system that is configured to compensate for chromatic aberration caused by a lens assembly (e.g., a metalens). The imaging system may include a metalens and a camera module. The metalens may provide image light to the camera module. The camera module may include an optical splitter, three image sensors, and processing logic. The optical splitter may be used to separate the image light into red, green, and blue color components. The optical splitter may be configured and positioned to direct the red, green, and blue color components to individual image sensors. An advantage of using a single image sensor to capture a single color component of light is that each color component may receive more photon input, which may allow each color to be better captured or represented. The processing logic may adjust image data for each of the color components to compensate for chromatic aberration. Processing logic may generate a single chromatic aberration corrected image by recombining the adjusted image data from each of the color components.

Chromatic aberration correction, by the processing logic or by the camera module, may include shifting each of the three color component images by a certain (e.g., predetermined) number of pixels. Chromatic aberration may occur when the red light, green light, and blue light of image light refract and exit at different angles upon exiting a lens or other optical element. The exit angle for a ray may be defined as the angle between the ray that is exiting an exit surface and the normal to the exit surface of the optical element. Red light tends to exit an optical element with a lower exit angle than green light, and green light tends to exit an optical element with a lower exit angle than blue light. As a result, the focal point for each red, green, and blue color component may appear (in a chromatic aberration distorted image) to be at different locations. In other words, different color components for a particular object or point in space will appear in different locations in a captured image, which may cause blurring. Locations in a captured image are typically addressed with reference to the pixels of an image sensor used to capture the image. By capturing and analyzing a known color image, calibration information may be determined. The calibration information may include a number of pixels needed to move each of the color components in order to cause each color component of an object (e.g., in the known color image) to appear at the same pixel location in images captured by each of the three different image sensors. As an illustrative example, in one implementation, the color calibration information used to correct or compensate for chromatic aberration may include shifting a red color component image down 60 pixels, shifting a green color component image up 5 pixels, and shifting a blue color component image up 40 pixels and to the left 10 pixels. Actual calibration information may vary by implementation based on the distances between the lens, optical splitter, and image sensors, for example. Correcting for chromatic aberration may include shifting each of the three color component images by a number of pixels (determined through calibration) prior to recombining the three color component images into a single image.

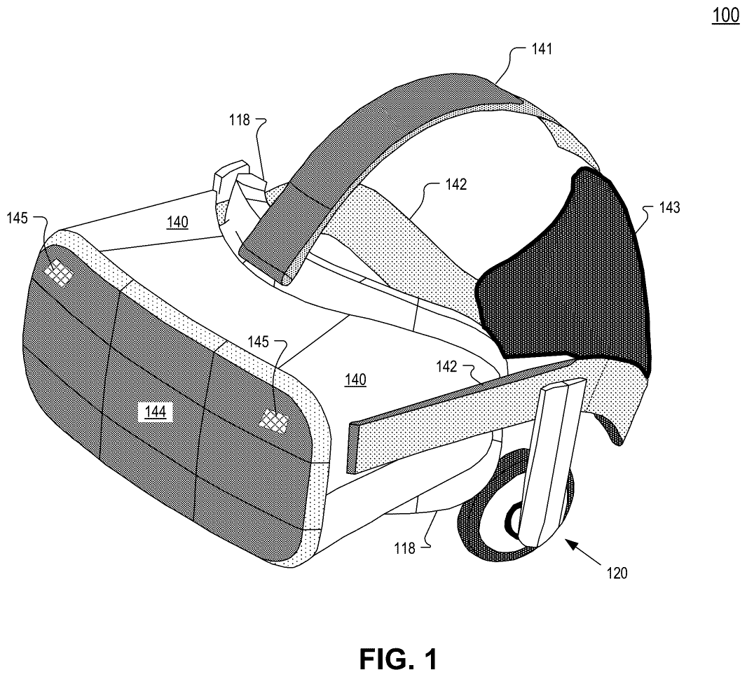

The apparatus, system, and method for an imaging system that is configured to compensate for chromatic aberration is described in this disclosure enabling the use of advanced optical elements, such as metalenses and other metaoptics, in a head mounted display. These and other embodiments are described in more detail in connection with FIGS. 1-6.

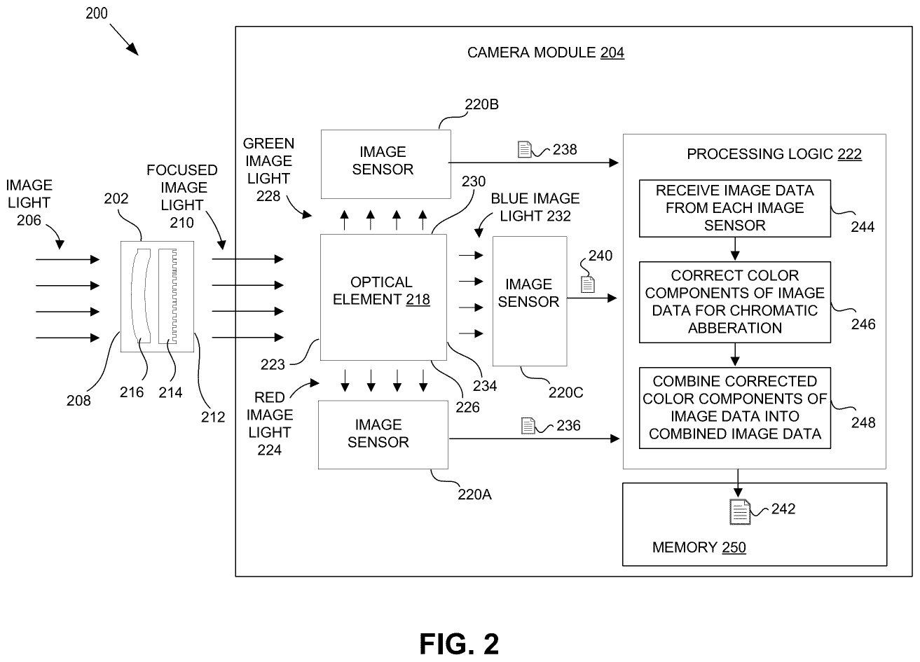

FIG. 1 illustrates a head-mounted device (HMD) 100, in accordance with aspects of the present disclosure. As described further below, in embodiments, HMD 100 may include an imaging system that corrects for chromatic aberration in an image, as described below in connection with FIGS. 2-6. An HMD, such as HMD 100, is one type of head mounted device, typically worn on the head of a user to provide artificial reality content to a user. Artificial reality is a form of reality that has been adjusted in some manner before presentation to the user, which may include, e.g., virtual reality (VR), augmented reality (AR), mixed reality (MR), hybrid reality, or some combination and/or derivative thereof. The illustrated example of HMD 100 is shown as including a viewing structure 140, a top securing structure 141, a side securing structure 142, a rear securing structure 143, and a front rigid body 144. In some examples, the HMD 100 is configured to be worn on a head of a user of the HMD 100, where the top securing structure 141, side securing structure 142, and/or rear securing structure 143 may include a fabric strap including elastic as well as one or more rigid structures (e.g., plastic) for securing the HMD 100 to the head of the user. HMD 100 may also optionally include one or more earpieces 120 for delivering audio to the ear(s) of the user of the HMD 100.

The illustrated example of HMD 100 also includes an interface membrane 118 for contacting a face of the user of the HMD 100, where the interface membrane 118 functions to block out at least some ambient light from reaching the eyes of the user of the HMD 100.

Example HMD 100 may also include a chassis for supporting hardware of the viewing structure 140 of HMD 100 (chassis and hardware not explicitly illustrated in FIG. 1). The hardware of viewing structure 140 may include any of processing logic, wired and/or wireless data interface for sending and receiving data, graphic processors, and one or more memories for storing data and computer-executable instructions. In one example, viewing structure 140 may be configured to receive wired power and/or may be configured to be powered by one or more batteries. In addition, viewing structure 140 may be configured to receive wired and/or wireless data including video data.

Viewing structure 140 may include a display system having one or more electronic displays for directing light to the eye(s) of a user of HMD 100. The display system may include one or more of an LCD, an organic light emitting diode (OLED) display, or micro-LED display for emitting light (e.g., content, images, video, etc.) to a user of HMD 100.

In some examples, an imaging system 145 may be included in viewing structure 140. In some aspects, imaging system 145 includes a metalens and a camera module for compensating for chromatic aberration that may be an optical characteristic of the metalens. In some implementations, imaging system 145 may be used to provide external imaging information (e.g., boundaries or scene information) to the user interface of HMD 100 or to a user of HMD 100 as described in connection with FIGS. 2-6 below.

Advantageously, imaging system 145 may include a low-profile lens assembly that includes one or more metalenses. The low-profile lens assembly used with the camera module may enable compact integration of imaging system 145 into HMD 100 to improve the overall user experience with HMD 100, according to an embodiment.

FIG. 2 illustrates an imaging system 200, according to an embodiment of the disclosure. Imaging system 200 is an example implementation of imaging system 145 (shown in FIG. 1). Imaging system 200 may be configured to correct for chromatic aberration that may be a characteristic of a lens, a metalens, and/or a lens assembly. By correcting for chromatic aberrations, imaging system 200 enables use of low-profile optical elements, such as a metalens, that may reduce the profile, size, or overall height of imaging system 200, according to an embodiment. Imaging system 200 includes a lens assembly 202 and a camera module 204, according to an embodiment.

Lens assembly 202 receives image light 206 with an entrance surface 208 and provides focused image light 210 from an exit surface 212. Lens assembly 202 may include a metalens 214. Metalens 214 may be a low-profile optical element that receives image light 206 and transmits or provides focused image light 210. Metalens 214 may be configured to focus image light 206 (e.g., scene light or display light) onto camera module 204. Metalens 214 may have a thickness of approximately 100 nm, according to an embodiment. Metalens 214 may have a thickness that is in the range of 80 nm to 120 nm, according to an embodiment. By contrast, a conventional lens configured to operate similarly to metalens 214 may have a thickness of approximately 1 cm. Hence, implementation of metalens 214 into imaging system 200 may enable imaging system 200 to operate with a substantially lower profile than if implemented using a conventional lens. Lens assembly 202 may also include one or more additional lenses or optical elements 216 to provide focused image light 210 to camera module 204, according to an embodiment.

Camera module 204 is configured to receive focused image light 210 from lens assembly 202 and generate an image that has been corrected for chromatic aberration, according to an embodiment. Camera module 204 corrects chromatic aberration caused by a lens assembly by: receiving (focused) image light, separating the image light into component colors, capturing each of the component colors with a corresponding or dedicated image sensor, correcting image data for each color component, and combining the individual color component imaging data into image data representing an image that has been corrected for chromatic aberration, according to an embodiment. Camera module 204 includes an optical element 218, image sensors 220 (individually, image sensor 220A, 220B, and 220C), and processing logic 222, according to an embodiment.

Optical element 218 receives focused image light 210 and separates focused image light 210 into a number of individual color components, according to an embodiment. Optical element 218 may receive focused image light 210 with an entrance surface 223. Optical element 218 may provide separated color components as red image light 224 that exits from an exit surface 226, as green image light 228 that exits from an exit surface 230, and as blue image light 232 that exits from an exit surface 234, according to an embodiment.

To separate focused image light 210, optical element 218 may include a number of features. Optical element may be an optical prism made of glass, plastic, or another light-transmissive material that separates white light into a number of color components (e.g., red, green, blue). Optical element 218 may be a dichroic cube having two or more internal dichroic surfaces. Each of the dichroic surfaces may reflect one specific color component of light while transmitting other color components of light, as described in further detail below. Although optical element 218 is described as separating white light into three color components, optical element 218 may alternatively be configured to separate white light into more color components (e.g., yellow, orange, blue, purple, green, and red) or fewer color components.

Image sensors 220 are positioned and optically coupled to optical element 218 to receive the color components of focused image light 210 and to convert the color components into image data that represents a specific color component of focused image light 210, according to an embodiment. Image sensors 220 may be complementary metal oxide semiconductor (“CMOS”) image sensors or charge-coupled device (“CCD”) image sensors. Image sensor 220A may receive and convert red image light 224 into image data 236 that represents the red color component of focused image light 210. Image sensor 220B may receive and convert green image light 228 into image data 238 that represents the green color component of focused image light 210. Image sensor 220C receives and converts blue image light 232 into image data 240 that represents the blue color component of focused image light 210. Image sensors 220 are communicatively coupled (e.g., through wired and/or wireless communication channels) to processing logic 222 to provide image data 236, 238, and 240 to processing logic 222 for chromatic aberration correction, according to an embodiment.

Processing logic 222 is communicatively coupled to image sensors 220 to receive image data 236, 238, and 240, according to an embodiment. Processing logic 222 may include circuitry, logic, instructions stored in a machine-readable storage medium, ASIC circuitry, FPGA circuitry, and/or one or more processors. Processing logic 222 may perform a number of operations on image data 236, 238, and 240 to generate image data 242 that represents focused image light 210, after receiving chromatic aberration correction. According to an embodiment, processing logic 222 performs operations illustrated by operation blocks 244, 246, and 248 to generate image data 242 from image data 236, 238, and 240.

At operation block 244, processing logic 222 receives image data from each image sensor, according to one embodiment. Image data 236, 238, and 240 concurrently represent focused image light 210 at a particular moment in time, according to an embodiment. Operation block 244 proceeds to operation block 246, according to an embodiment.

At operation block 246, processing logic 222 corrects color components of image data for chromatic aberration, according to an embodiment. Chromatic aberration may occur when red light, green light, and blue light refract and exit at different angles upon exiting a lens assembly 202. The exit angle for a ray may be defined as the angle between the ray that is exiting and the normal to the surface of the optical element. Red light tends to exit an optical element with a lower exit angle than green light, and green light tends to exit an optical element with a lower exit angle than blue light. As a result, the focal point for each red, green, and blue color component may appear in an image to be at different locations. In other words, different color components for a particular object or point in space will appear in different locations in a captured image. Locations in a captured image are typically addressed with reference to the pixels of an image sensor used to capture the image. By capturing and analyzing a known color image, calibration information may be determined. The calibration information may include a number of pixels needed to move each of the color components in order to cause each color component of an object to appear at the same pixel location in each of the three different image sensors. For example, in one implementation, the color calibration information used to correct or compensate for chromatic aberration may include shifting a red color component image down 60 pixels, shifting a green color component image up 5 pixels, and shifting a blue color component image up 40 pixels and to the left 10 pixels. Actual calibration information may vary by implementation based on the distances between the lens, optical splitter, and image sensors, for example. Correcting for chromatic aberration may include shifting each of three color component images by a number of pixels (determined through calibration) prior to recombining the three color component images into a single image represented by image data 242. Operation block 246 proceeds to operation block 248, according to an embodiment.

At operation block 248, processing logic 222 combines corrected color components of image data into combined image data, according to an embodiment. The combined image data is image data 242, which processing logic 222 may save (e.g., to memory 250) or may transmit to one or more other systems or processors.

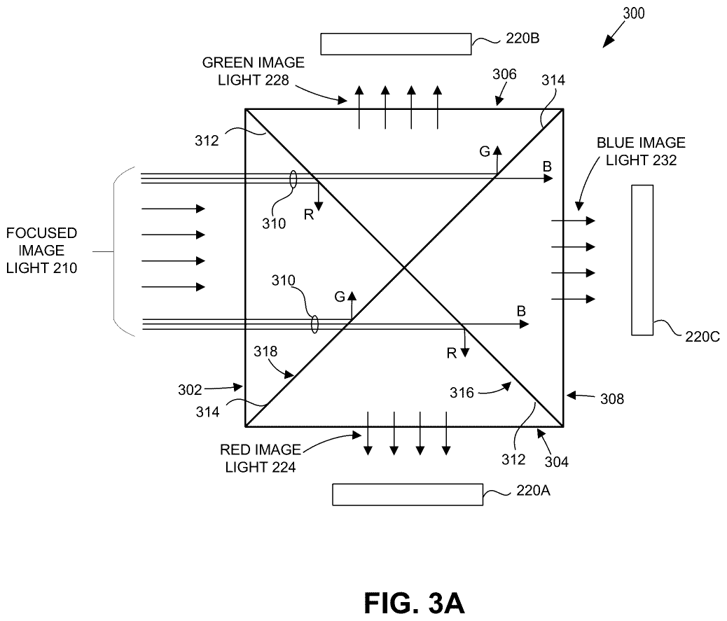

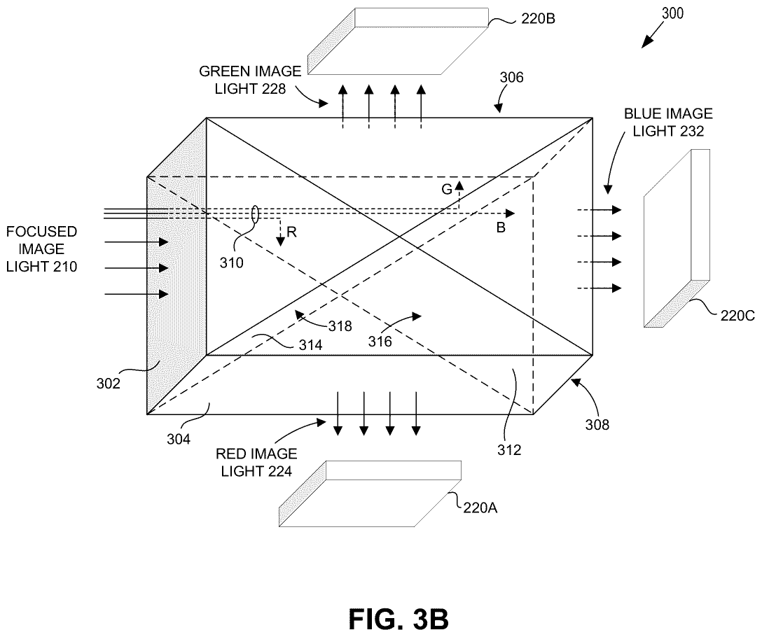

FIGS. 3A and 3B represent example implementations of optical element 218 (shown in FIG. 2).

FIG. 3A illustrates a top view of an optical element 300, according to an embodiment. Optical element 300 may be a transparent cube fabricated from glass, polymer, or another light-transmissive material. Optical element 300 is an optical prism that separates light (e.g., white light) into a number of color components, according to an embodiment. Optical element 300 may receive focused image light 210 and may separate focused image light 210 into a number of color components. Optical element 300 is configured to separate focused image light 210 into three color components (e.g., a red color component, a green color component, and a blue color component), according to an embodiment. In alternative implementations, optical element 300 may be configured to separate focused image light 210 into more than three or fewer than three color components. Optical element 300 separates focused image light 210 into red image light 224, green image light 228, and blue image light 232. Optical element 300 enables the color components of focused image light 210 to be received separately by image sensors 220.

To separate focused image light 210 into a number of color components, optical element 300 includes an entrance surface 302, an exit surface 304, an exit surface 306, and an exit surface 308, according to an embodiment. Optical element 300 transmits red image light 224 through exit surface 304 onto image sensor 220A, transmits green image light 228 through exit surface 306 onto image sensor 220B, and transmits blue image light 232 through exit surface 308 onto image sensor 220C, according to an embodiment.

Optical element 300 includes a number of dichroic surfaces that are configured to separate color components from focused image light 210, according to an embodiment. Focused image light 210 is represented as a number of arrows of, for example, white light, which can be further broken down into individual color component rays 310. The color component rays 310 of focused image light 210 are used to illustrate the reflective and transmissive characteristics of the illustrated dichroic surfaces. However, is to be understood that color component rays 310 could be represented with more color components and/or using a different color component nomenclature. Optical element 300 includes an internal surface 312 and an internal surface 314. Internal surface 312 is configured to reflect a red component of light and transmit green and blue components of light, according to an embodiment. Internal surface 312 may include or be coated with a red dichroic layer 316 that operates as a mirror to reflect red components of focused image light 210 and that transmits blue and green components of focused image light 210. Internal surface 314 may include or be coated with a green dichroic layer 318 that operates as a mirror to reflect green components of focused image light 210 and that transmits blue and red components of focused image light 210.

In operation, optical element 300 receives focused image light 210 with entrance surface 302. Focused image light 210 propagates into optical element 300 through entrance surface 302. At internal surface 312, red components of focused image light 210 are reflected towards exit surface 304 and exit through exit surface 304 as red image light 224. Green components of focused image light 210 are reflected off of internal surface 314 towards exit surface 306. Green components of focused image light 210 exit through exit surface 306 as green image light 228, according to an embodiment. Blue components of focused image light 210 are transmitted through internal surface 312 and internal surface 314 towards exit surface 308. Blue components of focused image light 210 exit through exit surface 308 as blue image light 232, according to an embodiment.

Using dichroic layers and internal surfaces, optical element 300 separates focused image light 210 into three different color components, according to an embodiment. Internal surface 312 and internal surface 314 may alternatively be referred to as reflective surfaces, dichroic surfaces, and/or selectively mirrored surfaces. Internal surface 312 is positioned within optical element 300 at a diagonal that spans between exit surface 306 and exit surface 304. Internal surface 314 extends at a diagonal from exit surface 304 to exit surface 306, according to an embodiment. Internal surface 312 and internal surface 314 may be positioned within optical element 300 perpendicularly to each other. Internal surface 312 may be disposed within optical element 300 so as to intersect with internal surface 314 at a 90 degree angle, at an angle that is less than 90 degrees, or at an angle that is greater than 90 degrees, according to various embodiments. Internal surface 312 and internal surface 314 may be positioned within optical element 300 so as to start and terminate at different corners of optical element 300, according to an embodiment.

FIG. 3B illustrates a perspective view of optical element 300, according to an embodiment.

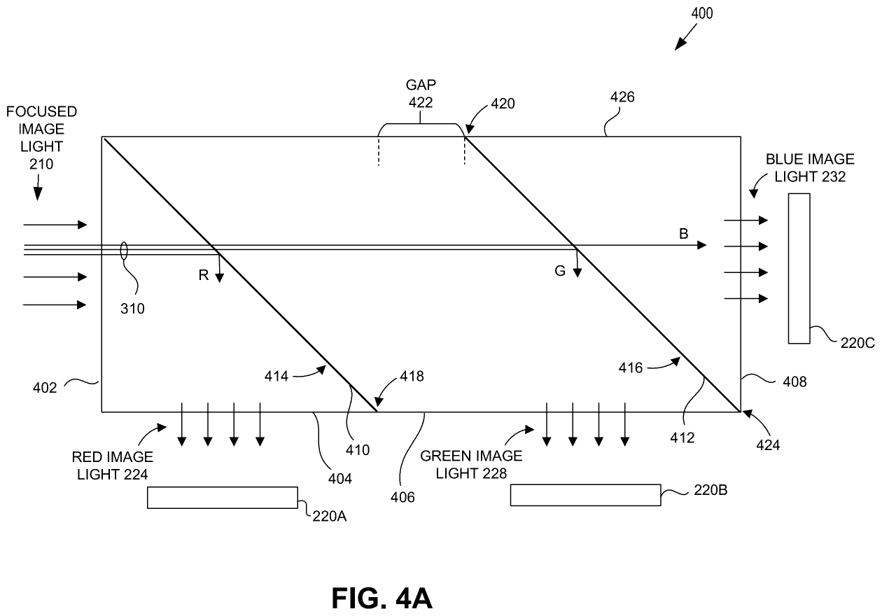

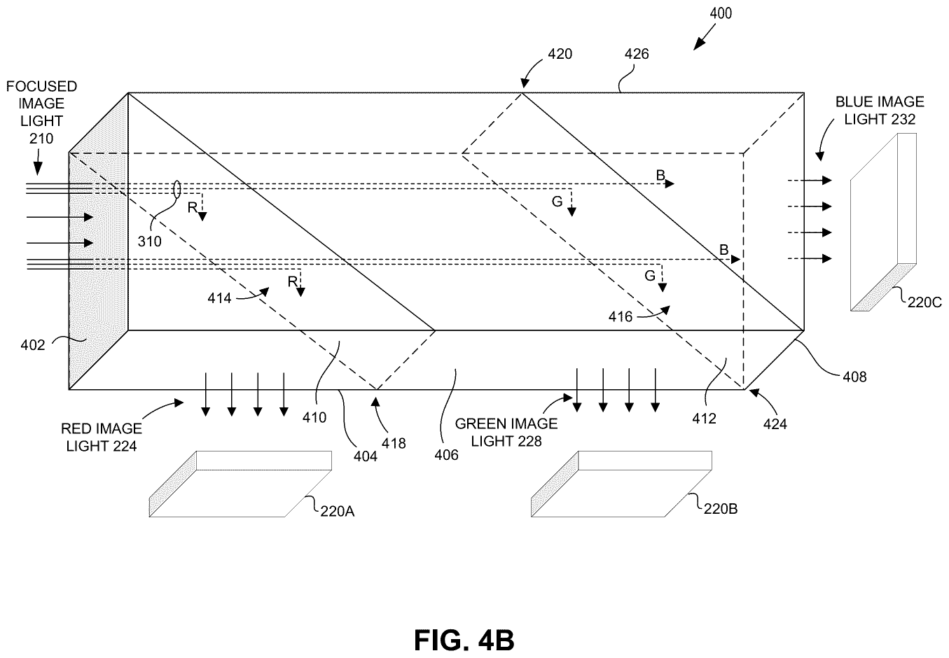

FIGS. 4A and 4B illustrate example implementations of optical element 218 (shown in FIG. 2), in accordance with embodiments of the disclosure.

FIG. 4 illustrates a top view of an optical element 400, according to an embodiment. Optical element 400 is an example implementation of optical element 218 (shown in FIG. 2), according to an embodiment. Optical element 400 is configured to receive focused image light 210 and separate focused image light 210 into a number of color components, according to an embodiment. Optical element 400 includes an entrance surface 402, an exit surface 404, an exit surface 406, and an exit surface 408, according to an embodiment. Optical element 400 may be configured to separate focused image light 210 so that red image light 224 exits through exit surface 404 onto image sensor 220A, so that green image light 228 exits through exit surface 406 onto image sensor 220B, and so that blue image light 232 exits through exit surface 408 onto image sensor 220C, according to an embodiment.

To separate focused image light 210 into color components, optical element 400 includes an internal surface 410 and an internal surface 412. The internal surface 410 may include a red dichroic layer 414 (e.g., dichroic coating and/or treatment) that reflects a red component of focused image light 210 towards exit surface 404 while transmitting green and blue components of focused image light 210, according to an embodiment. Internal surface 410 provides a physical barrier and boundary between exit surface 404 and exit surface 406. Internal surface 412 may include a green dichroic layer 416 that reflects a green component of focused image light 210 towards exit surface 406, which exits as green image light 228. Green dichroic layer 416 reflects the green component of focused image light 210 while passing the blue component of focused image light 210 to allow the blue component to exit through exit surface 408 as blue image light 232.

Internal surface 410 and internal surface 412 may be oriented within optical element 400 in a few different configurations. Internal surface 410 and internal surface 412 may be positioned and angled within optical element 400 to be parallel to each other, according to an embodiment. Internal surface 410 and internal surface 412 may be configured so as not to optically overlap within optical element 400, so green component light is directed towards exit surface 406 and not towards exit surface 404, according to an embodiment. An end 418 of internal surface 410 may be separated from an end 420 of internal surface 412 by the space of a gap 422, according to an embodiment. In an alternative implementation, internal surface 412 may be flipped across a horizontal axis so that end 420 is located at exit surface 406 and end 424 is located at exit surface 426, to cause green image light 228 to exit through exit surface 426, where image sensor 220B may alternatively be located to receive green image light 228. Other configurations of internal surface 410 and internal surface 412 may also be possible to enable optical element 400 to separate focused image light 210 into a number of color components that are transmitted onto image sensors 220, according to various embodiments.

FIG. 4B illustrates a perspective view of optical element 400, according to an embodiment.

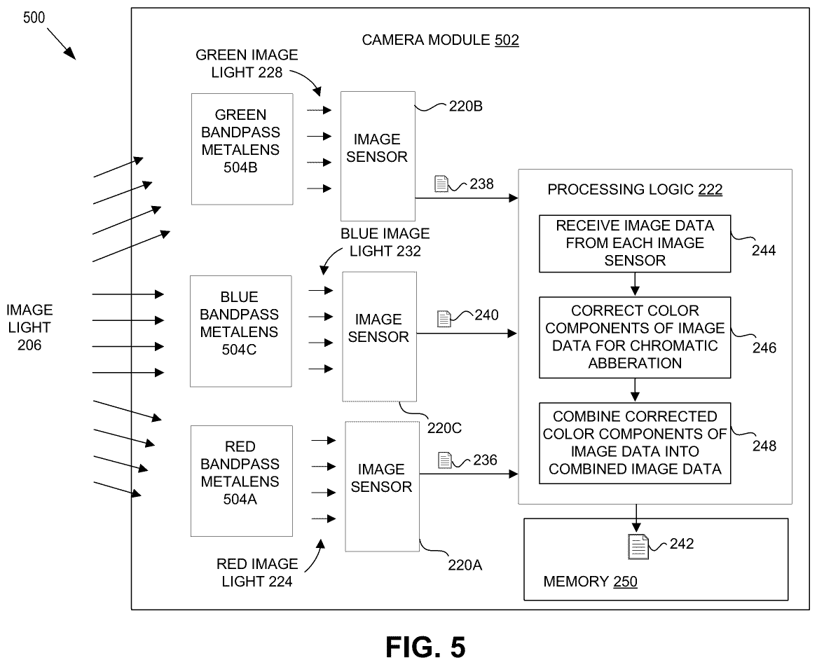

FIG. 5 illustrates an imaging system 500 that may be incorporated into HMD 100, according to an embodiment. Imaging system 500 may receive image light 206 and includes a camera module 502. Camera module 502 includes several similar components as camera module 204 (shown in FIG. 2). Camera module 502 separates image light 206 into a number of color components using a number of metalenses that correspond to each of the color components, according to an embodiment. Camera module 502 may include a red bandpass metalens 504A, a green bandpass metalens 504B, and a blue bandpass metalens 504C. Red bandpass metalens 504A may be configured to transmit the red component of image light 206 as red image light 224, while filtering, blocking, or reflecting other color components. Green bandpass metalens 504B may be configured to transmit the green component of image light 206 as green image light 228, while filtering, blocking, or reflecting other color components. Blue bandpass metalens 504C may be configured to transmit the blue component of image light 206 as blue image light 232, while filtering, blocking, or reflecting other color components. Red bandpass metalens 504A, green bandpass metalens 504B, and blue bandpass metalens 504C may collectively be referenced as bandpass metalenses 504. Within camera module 502, red bandpass metalens 504A is positioned and optically coupled to transmit red image light 224 to image sensor 220A, green bandpass metalens 504B is positioned and optically coupled to transmit green image light 228 to image sensor 220B, and blue bandpass metalens 504C is positioned and optically coupled to transmit blue image light 232 to image sensor 220C, according to an embodiment.

Positioning individual bandpass metalenses 504 proximate to image sensors 220 may be used to enable stereo vision. Stereo vision may be incorporated by, for example, determining spatial information (e.g., distances) using triangulation. Triangulation may be used by comparing differences between sizes, lengths, and angles of objects concurrently captured from the three different image sensors 220, since the distance between the image sensors is fixed and known prior to capturing images. Processing logic 222 include instructions for determining lengths and distances with triangulation, in addition to performing chromatic aberration correction, according to an embodiment.

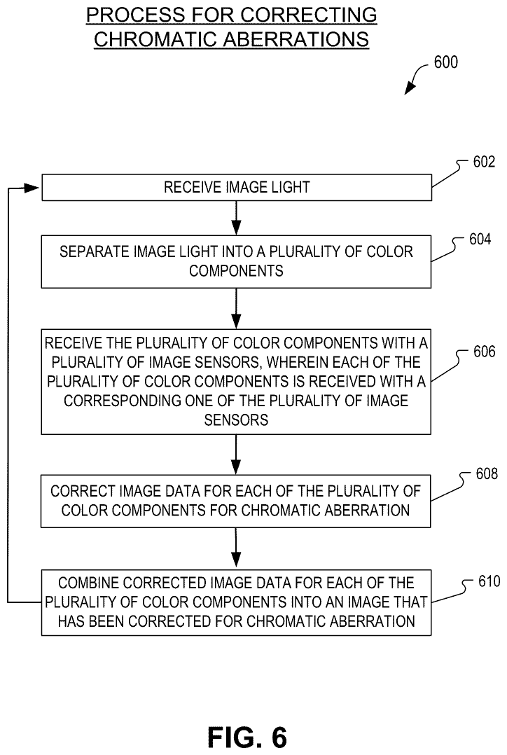

FIG. 6 illustrates a process 600 for correcting chromatic aberration from a lens assembly (e.g., a metalens or a conventional lens), according to an embodiment. Process 600 may be incorporated into HMD 100, imaging system 200, and/or imaging system 500. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In process block 602, process 600 receives image light, according to an embodiment. Process block 602 may proceed to process block 604, according to an embodiment.

In process block 604, process 600 separates image light into a plurality of color components, according to an embodiment. Process block 604 may proceed to process block 606, according to an embodiment.

In process block 606, process 600 receives the plurality of color components with a plurality of image sensors, wherein each of the plurality of color components is received with a corresponding one of the plurality of image sensors, according to an embodiment. Process block 606 may proceed to process block 608, according to an embodiment.

In process block 608, process 600 corrects image data for each of the plurality of color components for chromatic aberration, according to an embodiment. Process block 608 may proceed to process block 610, according to an embodiment.

In process block 610, process 600 combines corrected image data for each of the plurality of color components into an image that has been corrected for chromatic aberration, according to an embodiment. Process block 610 proceeds to process block 602 to cause process 600 to repeat, according to an embodiment.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone AMD, a mobile device or computing system, or any other hardware platform capable of providing artificial reality content to one or more viewers.

The term “processing logic” (e.g., processing logic 222) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g., memory 250) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A camera module comprising:
a lens assembly configured to receive incident light and provide image light, wherein the lens assembly includes a metalens, wherein the image light includes chromatic aberration from the metalens;
a plurality of image sensors;
an optical splitter optically coupled to the lens assembly to receive the image light, wherein the optical splitter separates the image light into color components, wherein the optical splitter is optically coupled to transmit each of the color components to corresponding ones of the plurality of image sensors and wherein the color components are transmitted along a path including two parallel internal surfaces separated by a gap within a same optical element and a spacing of the gap is determined to avoid optical overlap among the color components along the path; and
processing logic coupled to the plurality of image sensors, wherein the processing logic receives image data for each of the color components from the plurality of image sensors
and combines the image data for each of the color components to generate a chromatic aberration corrected image.

2. The camera module of claim 1, wherein the optical splitter includes a first mirror configured to reflect the first of the color components onto a first of the plurality of image sensors and configured to pass the second and the third of the color components.

3. The camera module of claim 2, wherein the optical splitter includes a second dichroic mirror configured to reflect the second of the color components onto a second of the plurality of image sensors and configured to pass the third of the color components onto a third of the plurality of image sensors.

4. (canceled)

5. The camera module of claim 1, wherein the optical splitter is an optical prism having a shape of a rectangle.

6. The camera module of claim 1, wherein the optical splitter includes an entrance surface, a first exit surface, a second exit surface, and a third exit surface, wherein the entrance surface receives the image light, wherein a first of the plurality of image sensors is positioned to receive the first of the color components from the first exit surface, wherein a second of the plurality of image sensors is positioned to receive the second of the color components from the second exit surface, wherein a third of the plurality of image sensors is positioned to receive the third of the color components from the third exit surface.

7. The camera module of claim 1, wherein the lens assembly includes a first lens optically coupled to a second lens, wherein the second lens is the metalens.

8. The camera module of claim 1, wherein the metalens has a thickness in a range of 80 nm to 120 nm.

9. A head mounted display comprising:
a lens assembly positioned to receive incident light and provide image light, wherein the lens assembly includes a metalens, wherein the image light is transmitted from the lens assembly with chromatic aberration from the metalens; and
a camera module optically coupled to the lens assembly to receive the image light from the lens assembly, the camera module including:
a plurality of image sensors;
an optical splitter that receives the image light and that separates the image light into color components, wherein the optical splitter is optically coupled to transmit each of the color components along a path to corresponding ones of the plurality of image sensors and the path includes two parallel internal surfaces separated by a gap within a same optical element and a spacing of the gap is determined such that first and second color components avoid optical overlap which traveling along the path;
processing logic coupled to the plurality of image sensors, wherein the processing logic receives image data for each of the color components from the plurality of image sensors; and
wherein the processing logic combines the image data for the color components to generate a chromatic aberration corrected image.

10. The head mounted display of claim 9, wherein the optical splitter includes a first dichroic mirror configured to reflect the first of the color components onto a first of the plurality of image sensors and configured to pass the second and the third of the color components.

11. The head mounted display of claim 10, wherein the optical splitter includes a second dichroic mirror configured to reflect the second of the color components onto a second of the plurality of image sensors and configured to pass the third of the color components onto a third of the plurality of image sensors.

12. The head mounted display of claim 9, wherein the optical splitter includes an entrance surface, a first exit surface, a second exit surface, and a third exit surface, wherein the entrance surface receives the image light, wherein a first of the plurality of image sensors is positioned to receive the first of the color components, wherein a second of the plurality of image sensors is positioned to receive the second of the color components, wherein a third of the plurality of image sensors is positioned to receive the third of the color components.

13. The head mounted display of claim 9, wherein the lens assembly includes a first lens optically coupled to a second lens, wherein the second lens is the metalens.

14. The head mounted display of claim 9, wherein the metalens has a thickness in a range of 80 nm to 120 nm.

15. A method of correcting chromatic aberration for a metalens comprising:
providing image light with a lens assembly, wherein the lens assembly includes a metalens, wherein the image light includes chromatic aberration from the metalens;
receiving, with an optical splitter, the image light from the lens assembly;
separating the image light, with the optical splitter, into a plurality of color components that include a first color component, a second color component, and a third color component;
receiving the first, second, and third color components with a corresponding one of a first image sensor, a second image sensor, and a third image sensor;
providing first image data with the first image sensor, second image data with the second image sensor, and third image data with the third image sensor, wherein the color components are transmitted along a path including two parallel internal surfaces separated by a gap within a same optical element and a spacing of the gap is determined to avoid optical overlap among the first and second color components along the path; and
combining the first, second, and third image data into a combined image that has at least partially been corrected for chromatic aberration from the metalens.

16. (canceled)

17. The method of claim 15, wherein the optical splitter includes a first dichroic surface to reflect the first color component onto the first image sensor, wherein the optical splitter includes a second dichroic surface to reflect the second color component onto the second image sensor.

18. (canceled)

19. The method of claim 15 further comprising:
calibrating processing logic for color-specific refraction by imaging a predetermined pattern to generate calibration image data; and
determining a number of pixels to shift image data for each of the plurality of color components at least partially based on the calibration image.

20. The method of claim 15, wherein the optical splitter is an optical prism having at least two dichroic surfaces internal to the optical splitter.
